(19) United States
(12) Patent Application Publication
(10) Pub. No.: US 2009/0132348 A1
(43) Pub. Date: May 21, 2009

(54) METHOD FOR DEAL-BASED PRICING AND ESTIMATION OF DEAL WINNING PROBABILITY USING MULTIPLE PROSPECTIVE MODELS

(75) Inventors: Frank H. Bria, Gilbert, AZ (US); Roger R. Gung, Scottsdale, AZ (US); Tao Kang, Tempe, AZ (US)

Correspondence Address: THORPE NORTH & WESTERN, LLP., P.O. Box 1219, SANDY, UT, 84091-1219, US

(73) Assignee: Response Analytics, Inc., Scottsdale, AZ (US)

(21) Appl. No.: 12/272,660

(22) Filed: Nov. 17, 2008

Related U.S. Application Data
(60) Provisional application No. 60/988,542, filed on Nov. 16, 2007.

(51) Int. Cl. G06Q 40/00; G06Q 30/00; G06Q 50/00

(52) U.S. Cl. 705/10; 705/38

(57) ABSTRACT

A system and method for determining an expected profit obtained through financing or selling a commodity is disclosed. Financial information from a selected customer is obtained and entered into a computer. Historical data from a remote database is requested. The requested data is a subset of the historical data in the database, with data selected based on the financial information. A plurality of curve fitting models are applied to the historical data subset to form a plurality of historical data subset fitted curves. A likelihood probability value of each fitted curve is calculated and a best fitted curve is selected. A profit function curve and the best fitted curve are combined to form an expected profit curve. Information from the expected profit curve is displayed to enable a finance offer or offer for sale to be made based on the information.

### CLAIM OF PRIORITY

Priority of U.S. Provisional patent application Ser. No. 60/988,542 filed on Nov. 16, 2007 is claimed and is incorporated herein in its entirety.

### BACKGROUND OF THE INVENTION

The nearly ubiquitous use of computers and the internet has enabled access to vast amounts of knowledge and data. Data on a broad range of subjects and topics can be collected, organized, stored, and analyzed to enable a better understanding of a selected topic. When the amount of data is relatively large, a statistical analysis can be useful in interpreting the data. Statistical methods can then be used to summarize or describe a collection of data. In addition, patterns in the data can be used to draw inferences about a process or topic being studied.

### SUMMARY OF THE INVENTION

A system and method for determining an expected profit obtained through financing or selling a commodity is disclosed. Financial information from a selected customer is obtained and entered into a computer. Historical data from a remote database is requested. The requested data is a subset of the historical data in the database, with data selected based on the financial information. A plurality of curve fitting models are applied to the historical data subset to form a plurality of historical data subset fitted curves. A likelihood probability value of each fitted curve is calculated and a best fitted curve is selected. A profit function curve and the best fitted curve are combined to form an expected profit curve. Information from the expected profit curve is displayed to enable a finance offer or offer for sale to be made based on the information.

### BRIEF DESCRIPTION OF THE DRAWINGS

FIG. 1 is an illustration of a logit function used to fit a winning probability curve to a data-set;

FIG. 2 is an illustration of a probit function used to fit a winning probability curve to a data-set;

FIG. 3 is an illustration of a win-loss normal distribution function used to fit a winning probability curve to a data-set in accordance with an embodiment of the present invention;

FIG. 4 is an illustration of a win-loss gamma distribution function used to fit a winning probability curve to a data-set in accordance with an embodiment of the present invention;

FIG. 5 is an illustration of a horizontally reversed gamma cumulative density function used to fit a winning probability curve to a data-set in accordance with an embodiment of the present invention;

FIG. 6 is an illustration of a profit function applied to a best fit winning probability curve to derive an expected profit curve in accordance with an embodiment of the present invention;

FIG. 7 is a block diagram of a system for determining an expected profit obtained through financing a sale of a commodity; and

FIG. 8 is a flow chart depicting a method for determining an expected profit obtained through financing a sale of a commodity in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Statistical analyses on sets of data can be accomplished by plotting a set of data having similar characteristics. Patterns may develop when the data is plotted. For example, when a class is given a well developed test and the results of the test are plotted for each of the students in the class, a bell shaped pattern can develop. The bell shaped pattern shows that most of the students received results that were somewhere in the middle of the possible range of results, while fewer students test results were either exceptional or poor.

A mathematical model can then be used to fit a curve to the data. The curve can enable an analyst to interpolate and predict results in areas where no data actually exists. Larger sets of data can enable more precise curves to be fit to the data, which in turn can provide more accurate interpolations. The accuracy of the interpolations, however, is also limited by the mathematical model used to create the curve to fit the known data. The mathematical model may imbue a certain amount of error in the curve relative to the actual results. The error may be relatively constant throughout the curve, or may be weighted more heavily over one or more sections of the curve. The error can result in a reduced accuracy in interpolating between known sets of data. This error can result in a diminished ability of an analyst to predict a desired result based on a set of data.

In accordance with an embodiment of the present invention, it has been discovered that the error caused by a certain mathematical model used in fitting a data set can be reduced by using a plurality of prospective models and measuring the likelihood of each fitted model over an empirical winning probability. The fitted model with the highest empirical winning probability (likelihood) can then be considered to be the best model to fit the selected data set. The winning prospective model can then be used by an analyst to more accurately predict results based on the curve fit to the data set using the winning prospective model. The type of model that wins can change with each data set. One type of model may prove more accurate than another for a certain type of data set, while another model may be more accurate for a different type of data set. By using a plurality of prospective models to fit a curve to a data set and determining which model best fits the data set, error introduced by a particular model can be substantially reduced.

For example, new and used automobile dealers have collected a vast amount of data over the years on car buyers. This data can be used to predict the likelihood of an automobile purchaser to accept a deal proposed by a seller. An automobile sales person typically has a limited number of opportunities to make an offer that is acceptable to a purchaser. If the first offer by the sales person is too high, the sales person risks losing the interest of the buyer. If the offer is too low, the sales person risks losing potential profit. A better understanding of the purchaser's likelihood for accepting a certain offer can reduce the risk of losing the potential purchaser, increase the potential profit, and minimize the amount of time that is spent in negotiating a final deal. This information can be derived from the historical data that has been collected based on previous automobile purchases.

While large data sets can provide for more accurate curve fitting, the accuracy can depend on the similarity of the data to the subject or topic to which it will be applied. In the example above, there are very large data sets available for a wide variety of different types of people and car purchases. The entire set of information that has been recorded on previous automobile purchasers can be reduced by selecting a subset of the data based on similarities of previous purchasers with a current purchaser.

Details that can be used to limit the data set include whether the purchaser is a direct or indirect purchaser. A direct purchaser is one who is personally interacting with an automobile dealership or lending institution. An indirect purchaser is one who is reviewing available auto or loan information from a remote location, such as on the internet. Additional limitations can include the region (area of the country) in which the purchaser is located, whether the selected car is new or used, the purchaser's credit rating, the loan to value (LTV) amount (ratio of the value of the car to the amount of the loan), and the term of payment desired by the purchaser. Certain limitations may be grouped into segments. For example, purchasers who select a payment term between 48 months and 60 months may be grouped into a single subset of the collected data. Purchasers whose loan has an LTV of between 1.0 and 1.25 may be grouped into a subset, and so forth.

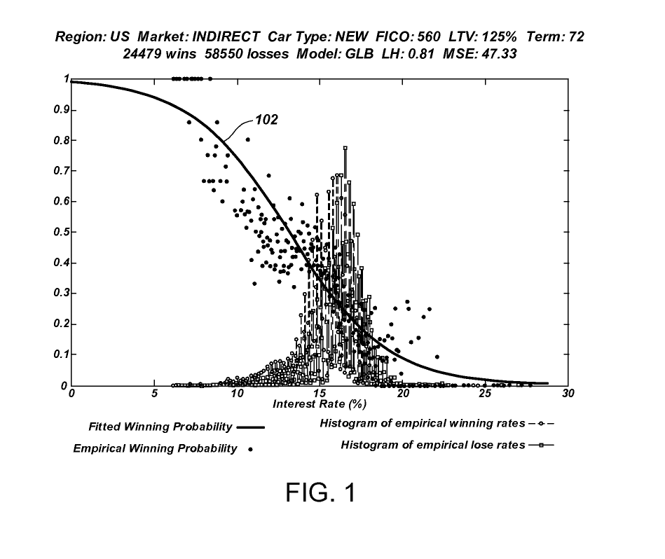

A sales person can obtain financial information of a selected customer, such as the identifying factors discussed above. The financial information can be entered into a computer. For example, the financial information can be entered using a graphical user interface viewable on the computer. The computer can be used to access a database and select a sub-set of available data that conforms to the identifying factors. This subset can be used to more accurately predict the behavior of the purchaser. For example, FIG. 1 illustrates a computer generated chart of a sub-set of data representing the interest rate paid by previous automobile purchasers. As can be seen at the top of the chart, the subset represents data for automobile purchasers with selected identifying factors. The factors in this example include that the purchaser is within the United States, the purchaser type that is indirect, the car type is new, the purchaser's FICO credit rating score is 560, the LTV is 125% and the term of the loan is 72 months. Within those identifying factors, there is data recorded for 83,029 offers. The data is plotted in a normalized histogram illustrating the historical probability for a purchaser to accept or reject an offer over a range of interest rates based on recorded data. The plot has been normalized so that all of the offers are between zero and one, representing zero percent to 100 percent acceptance or rejection rates. Out of the 83,029 offers, 24,479 offers were accepted and 58,550 offers were rejected. The 24,479 offers that were accepted are referred to as the winning probability.

A mathematical model is selected and used to generate a logit winning probability curve 102 that is fitted to the winning probability data points based on the logit mathematical model, as shown in FIG. 1. Using the curve, the probability of selecting an interest rate for a purchaser within the identifying factors shown can be determined by interpolating along the curve between the plotted data. For example, a sales person or analyst can determine using the curve that there is approximately an 80 percent chance that a purchaser within these identifying factors will accept an offer with an interest rate of 10 percent. At an interest rate of 15 percent, there is only about a 35 percent chance that the purchaser will accept an offer, based on historical data.

Of course, as previously discussed, there is some amount of error in the mathematical model compared to real world results. In order to provide practical results that are usable in the real world, the error must be minimized to a point where the predicted results substantially compare with actual results. For example, if distribution of the data set is skewed then a normal distribution may not be the best way to model the data. Instead, a gamma distribution may be the best way to fit a curve to the data.

A plurality of different types of mathematical models can be used to fit a curve to a data set, to form a plurality of fitted curves, as can be appreciated. In one embodiment, a logit model can be used to fit a curve to a selected data set. The logit model is a well known model that was developed in 1944 by Joseph Berkson. The logit model is part of a larger family called logistic functions. The logit model is defined as follows:

$$logit ( p ) = log ( \frac{p}{1 - p} ) = log ( p ) - log ( 1 - p ) \qquad ( 1 )$$

where p is a probability between 0 and 1. The logit model is used to fit the curve to the normalized winning probability data set illustrated in FIG. 1.

As previously discussed, the prediction made by the fitted curve is limited by how well the curve fits the plotted data. Once a specific type of curve based on a selected mathematical model is fit to a particular data set, the fit of the curve to the data set can be empirically measured.

In one embodiment of the present invention, the likelihood of a fitted winning probability curve over an empirical winning probability curve can be used to evaluate the quality of model fitting and can be used to select the best model. The model with the highest likelihood can be selected as the best fitted model. However, the traditional likelihood measurement is not appropriate for comparing the performance of various fitted models since it is not normalized to a selected scale, such as the 0 to 1 normalization illustrated in FIG. 1. In other words, the traditional likelihood measurement is not evaluated as accurately against empirical winning probability data.

To overcome the limitations of the traditional likelihood measurement, a modified likelihood measurement has been developed to measure how well various fitted models fit the empirical data. The modified likelihood measurement can be determined by calculating the empirical winning probability of each deal. This is the ratio of the number of winning deals (deals that were accepted by the purchaser) to the number of all deals that were given with the same price or price range. A set of deals being given within the same price range has the same empirical winning probability and the same fitted winning probability per fitted model.

Let aᵢ be the empirical winning probability of deal i. Let pᵢⱼ be the fitted winning probability of deal i using model j. The likelihood of fitted model j for deal i can be defined as:

$${L}_{ij} = ( 1 - \frac{\vert {a}_{i} - {p}_{ij} \vert}{{a}_{i}} ) {I}_{i} + ( 1 - \frac{\vert {a}_{i} - {p}_{ij} \vert}{1 - {a}_{i}} ) ( 1 - {I}_{i} ) \qquad ( 2 )$$

where Iᵢ=1 if the deal i is a winning deal and Iᵢ=0 if the deal i is a losing deal. The likelihood of fitted model j can be defined as:

$${L}_{j} = \frac{1}{n} {\sum }_{i = 1}^{n} {L}_{ij} \qquad ( 3 )$$

where n is the number of deals in the data set.

Thus, the likelihood probability, Lⱼ, is a number between zero and one that corresponds to how well the fitted winning probability curve fits the data set using model j. This value can be calculated using a computer. For example, in FIG. 1 using the logit model to form the fitted winning probability curve to the data set, the likelihood is calculated as 0.81. It may not be possible to know which type of model will yield the best results for a specific data set. Various models can be used to create different fitted winning probability curves based on the data set. The likelihood of each curve can then be calculated to determine how well each model fits the data set.

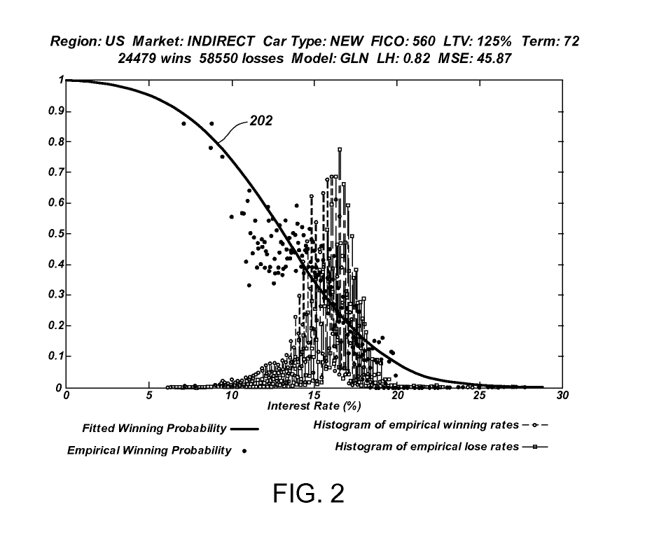

For example, a probit model is illustrated in FIG. 2. Like the logit model, the probit model is a well known model used in statistical analysis. The probit model was developed by Chester Ittner Bliss in 1934. In probability theory and statistics, the probit function is the inverse cumulative distribution function (CDF), or quantile function associated with the standard normal distribution. For the standard normal distribution (often denoted N(0, 1)), the CDF, commonly denoted Φ(z). Φ(z), is a continuous monotone increasing sigmoid function whose domain is the real line and range is [0,1]. As an example, consider that the N(0,1) distribution places 95% of probability between −1.96 and 1.96, and is symmetric around zero. It follows that

Φ(−1.96)=0.025=1−Φ(1.96).

The probit function gives the ‘inverse’ computation, generating a value of an N(0, 1) random variable, associated with specified cumulative probability. Formally, the probit function is the inverse of Φ(z), denoted Φ−1(p). Continuing the example,

probit(0.025)=−1.975=−probit(0.975).

In general,

Φ(probit(p))=p and probit(Φ(z))=z. (4),(5)

The normal distribution CDF and its inverse are not available in closed form and computation requires careful use of numerical procedures. However, the functions are widely available in spreadsheets and software for statistics and probability modeling. In computing environments where numerical implementations of the inverse error function are available, the probit function may be obtained as:

probit(p)=\sqrt{2}erf⁻¹(2p−1). (6)

where p is a probability between 0 and 1 and erf¹ is the inverse error function.

A probit winning probability curve 202 can be formed using the probit model to fit the curve to the data set, as illustrated in FIG. 2. The same data set used in FIG. 1 is also used in FIG. 2. Thus, it is possible to compare how well the logit model used in FIG. 1 and the probit model used in FIG. 2 fit the curve to the data using the modified likelihood equations (2) and (3). As can be seen in FIG. 2, the modified likelihood value (LH) from equation (3) for the winning probability curve 202 based on the probit model is 0.82, a slight improvement over the LH value in FIG. 1 using the logit model.

Additional models have been developed to provide alternative models to fit a curve to a selected data-set. While the logit and probit models provide substantially similar results, the additional models have been designed to fit different statistically common groupings of data sets. Developing models that fit different common groupings increases the probability that one of the models will fit a selected data-set. Thus, a system and method for determining a best fit for a winning probability model can include a plurality of different models designed to fit different statistically common groupings of data-sets.

One model that has been developed is referred to as win-loss normal distribution (WLND) model. The WLND model has been developed to fit a curve to a data-set having a relatively normal distribution. The WLND model can be employed to fit a winning probability curve with respect to a certain price or price range. A first step involves fitting a probability density function of a winning price as a normal distribution based on the histogram of winning deals over a price or price range. The probability density function of a winning price is defined as follows:

$${f}_{w} ( x ) = \frac{1}{{σ}_{w} \sqrt{2 π}} exp ( - \frac{{( x - {μ}_{w} )}^{2}}{2 {σ}_{w}^{2}} ) \qquad ( 7 )$$

where μ_{w} and σ_{w} are the mean and the standard deviation of a winning price respectively.

The probability density function of the loss price can be fit as a normal distribution based on the histogram of loss deals over a price or price range. The probability density function of the loss price is defined as follows:

$${f}_{l} ( x ) = \frac{1}{{σ}_{l} \sqrt{2 π}} exp ( - \frac{{( x - {μ}_{l} )}^{2}}{2 {σ}_{l}^{2}} ) \qquad ( 8 )$$

where μₗ and σₗ are the mean and the standard deviation of the loss price.

The winning probability of a given price x can be defined as:

$${p}_{w} ( x ) = \frac{{f}_{w} ( x ) {V}_{w}}{{f}_{w} ( x ) {V}_{w} + {f}_{l} ( x ) {V}_{l}} , \qquad ( 9 )$$

where f_{w}(x) is the probability density function of the winning price, and V_{W} and Vₗ are the numbers of winning deals and loss deals at all prices, respectively.

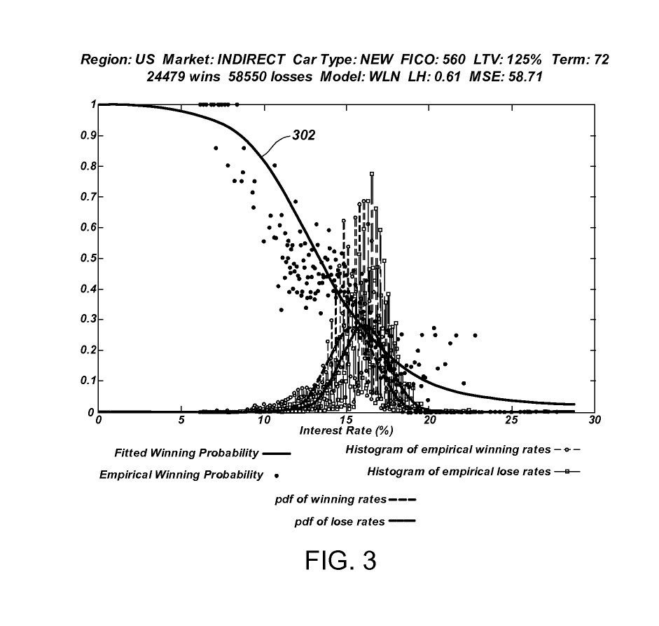

Equations 7 and 9 can be used to fit a WLND winning probability curve 302 to a data set, as illustrated in FIG. 3. The modified likelihood equations (2) and (3) can then be used to determine a modified likelihood value for the curve with respect to the data. As can be seen in FIG. 3, the modified likelihood value (LH) from equation (3) for the WLND winning probability curve 302 based on the WLND model is 0.61. Thus, the curve fit to the data set based on the WLND model does not fit the data set as well as the logit (FIG. 1) and probit (FIG. 2) models. However, the WLND model may be the best model to fit a different data-set.

In another embodiment of the present invention, a win-loss gamma distribution (WLGD) model may be used to fit a curve to a data set. The WLGD model has been developed to fit a curve to a data-set having a relatively gamma shaped distribution. The WLGD model can be used to fit a winning probability curve with respect to the probability density function of winning deals for a price or price range. The probability density function of a winning price is defined as follows:

$${f}_{w} ( x ) = {x}^{{k}_{w} - 1} \frac{exp ( - x / {θ}_{w} )}{Γ ( {k}_{w} ) {θ}_{w}^{{k}_{w}}} \qquad ( 10 )$$

where θ_{w} and k_{w} are the shape parameter and the scale parameter of the distribution. These parameters are maximum likelihood estimators of the underlying gamma distribution with given empirical data.

The probability density function of a losing price can be fit as a gamma distribution based on the histogram of the loss deals over the price. The probability density function of the loss price is defined as follows:

$${f}_{l} ( x ) = {x}^{{k}_{l} - 1} \frac{exp ( - x / {θ}_{l} )}{Γ ( {k}_{l} ) {θ}_{l}^{{k}_{l}}} \qquad ( 11 )$$

where θ₁ and kₗ are the shape parameter and the scale parameter of the distribution, respectively. The winning probability of a given price x can be defined as:

$${p}_{w} ( x ) = \frac{{f}_{w} ( x ) {V}_{w}}{{f}_{w} ( x ) {V}_{w} + {f}_{l} ( x ) {V}_{l}} \qquad ( 12 )$$

Where f_{w} (x) is the probability density function of the winning price, and V_{w} and Vₗ are the total numbers of winning deals and loss deals at all prices.

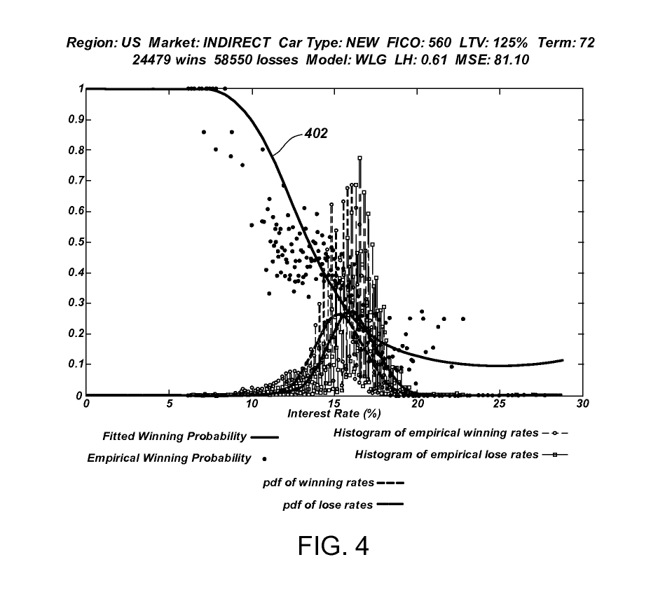

Equations 10 and 12 can be used to fit a WLGD winning probability curve 402 to a data set, as illustrated in FIG. 4. The modified likelihood equations (2) and (3) can then be used to determine a modified likelihood value. As can be seen in FIG. 4, the modified likelihood value (LH) from equation (3) for the WLGD winning probability curve 402 based on the WLGD model is 0.61. Thus, the curve fit to the data set based on the WLGD model does not fit the data set as well as the logit (FIG. 1) and probit (FIG. 2) models. However, like the WLND model illustrated in FIG. 3, the WLGD model shown in FIG. 4 may be the best model to fit a differently shaped data-set.

Another embodiment of the present invention provides a gamma cumulative density function model (GMF) used for curve fitting. The winning probability function with respect to price can be a horizontally reversed sigmoid function. This sigmoid function can be fitted as a cumulative density function of a probability distribution. Gamma distribution is recommended to fit the reversed winning probability function due to the following two reasons. First, a gamma distribution can fit virtually any sigmoid function by adjusting its shape parameter and scale parameter. Second, if a pricing decision is associated with k pricing factors (for example, when a product is composed of k components), and the winning probability function of each pricing factor follows a reversed exponential distribution with a mean θ, the winning probability function of overall pricing follows a reversed gamma distribution with shape parameter θ and scale parameter k.

The cumulative density function of a gamma distribution can be defined as follows:

$$F ( x ) = \frac{γ ( k , x / θ )}{Γ ( k )} \qquad ( 13 )$$

The winning probability of a given price x can be defined as:

p_{w}(x)=1−F(x) (14)

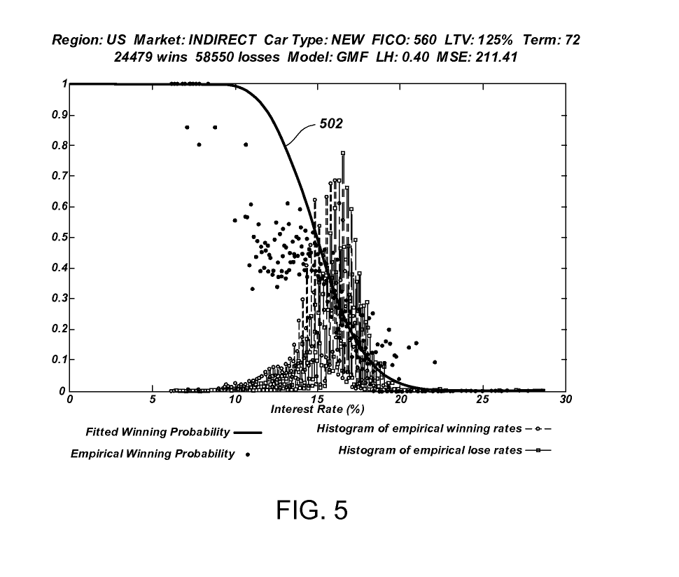

Equations 13 and 14 can be used to fit a GMF winning probability curve 502 to a data set, as illustrated in FIG. 5. The modified likelihood equations (2) and (3) can then be used to determine a modified likelihood value. As can be seen in FIG. 5, the modified likelihood value (LH) from equation (3) for the GMF winning probability curve 502 based on the GMF model is 0.40. Thus, the curve fit to the data set based on the GMF model does not fit the data set as well as the curves in FIGS. 1-4. However, the GMF model shown in FIG. 5 may be the best model to fit a differently shaped data-set.

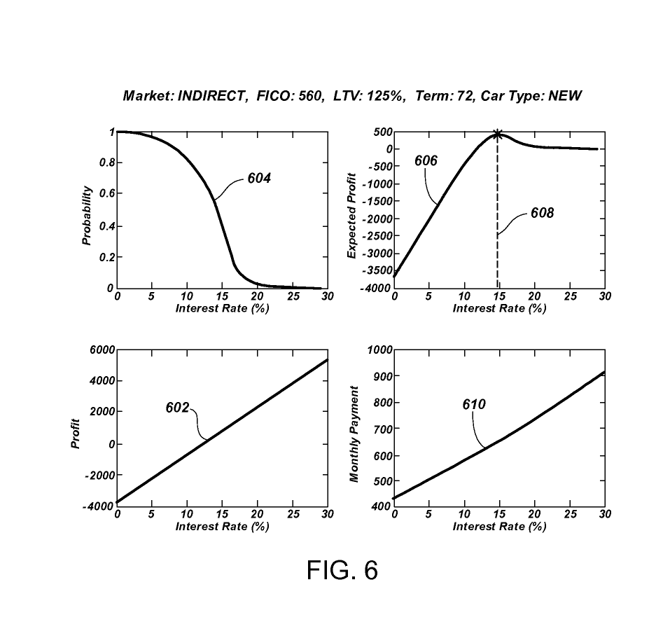

Once the best fitting curve for the selected data set has been selected, the curve can be used in conjunction with a profit function to determine the interest rate that will have the maximum profit for a sales person or entity. For example, a graph of a profit function 602 is illustrated in FIG. 6. The profit function, in this example, shows how much profit can be obtained by selling a product with financing over a range of interest rates. Intuitively, if a product is financed at a very low interest rate, the seller will have to subsidize the financing and the profit is negative. At very high interest rates, the profit will be substantial.

To determine the maximum profit that can be obtained by financing a product, such as an automobile, the best fitting winning probability curve can be selected. In the previously illustrated example, it was determined that the probit model provided the best fitting winning probability curve for the example data-set. Thus, it is assumed that this curve is the most accurate based on the historical data. The winning probability curve can be combined with the profit function to derive an expected profit curve 606. In one embodiment, the winning probability curve and the profit function curve can be multiplied piecewise to obtain the expected profit curve. For example, the winning probability curve can be divided into sections. In this example, the winning probability curve illustrates the probability of a purchaser accepting an offer at a selected interest rate. The plot can be broken into segments, such as 0.05% interest rate segments. Each segment can then be multiplied with a corresponding segment from the profit function 602. These values can then be plotted to obtain the expected profit curve 606. The piecewise multiplication example is not intended to be limiting. There are a variety of other mathematical methods that can also be used to combine the winning probability curve and the profit function curve, as can be appreciated.

The peak 608 of the expected profit curve 606 shows the maximum profit that can be obtained based on the probability of a purchaser accepting an agreement at a selected financing interest rate. Points to the left of the peak represent potentially lost profit by offering too low of an interest rate. Points to the right of the peak represent potentially lost profit due to a decreased probability that the offer will be accepted by the purchaser. Thus, the maximum expected profit can be obtained at the peak of the curve. An interest versus payment curve 610 can be used to determine a monthly payment for a purchaser at the interest rate obtained at the peak of the expected profit curve. For example, the maximum expected profit occurs at a financing rate of approximately 14.5%. The monthly payment for the commodity at 14.5% is approximately $650.00 in this example.

Information related to the expected profit curve 606 can be displayed on the computer to enable a salesperson to make an offer for sale or a finance offer to the customer for the commodity based on information in the expected profit curve. The information displayed may be the entire profit curve, showing the peak value. Alternatively, rather than showing a graphical display, the number corresponding to the peak value 608 of the profit curve may be displayed.

A salesperson can use the information provided in the expected profit curve 606 to make an informed decision in selecting an offer to make to a customer. Continuing with the example given in FIGS. 1-6, the salesperson may first offer to finance a commodity, such as a vehicle, at the interest rate that corresponds with the peak 608 value of the expected profit curve. If the customer rejects this offer, the salesperson can offer provide a second offer at a lower interest rate. Alternatively, the salesperson may make a first finance offer at an interest rate greater than the interest rate that corresponds with the peak. If the customer rejects this offer, the salesperson can provide a second offer at the peak 608 rate, or a rate slightly less than the peak rate.

Businesses selling commodities using financing may have established rules requiring their salespersons to stay within a defined margin about the peak 608 rate on the expected profit curve 606. A graphical user interface can be configured to allow a business to establish a range set about the peak 608 rate. The salesperson can be free to make multiple offers within the range. For example, the range in FIG. 6 may be the peak value of 14.5%+/−0.75%. So a salesperson is able to provide two or more offers within the range of 13.75% to 15.25% to the customer. Alternatively, some businesses may defer to the salesperson, who can determine based on their knowledge of the customer whether they should select a rate at, above, or below the peak 608 rate. Thus, the expected profit curve can be used as a tool by businesses and salespersons in determining the interest rate or price at which to offer a commodity for sale.

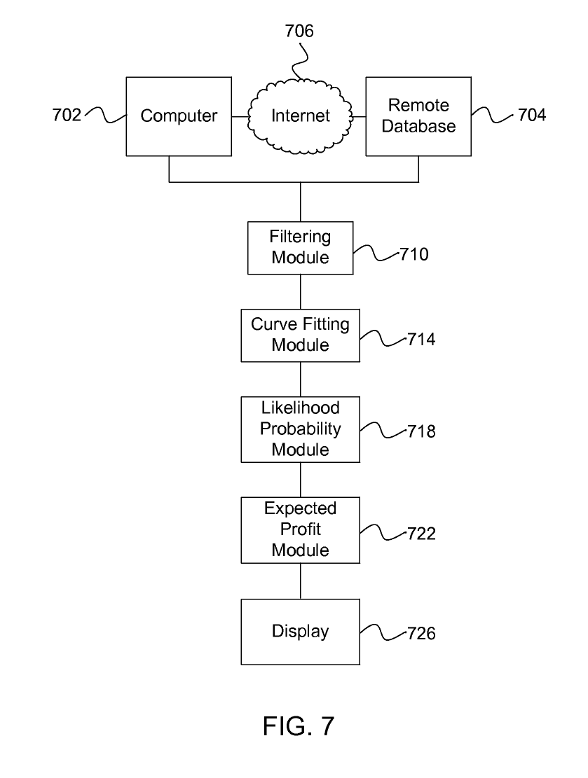

One embodiment of the present invention provides a system for determining an expected profit obtained through financing a sale of an automobile. An exemplary embodiment of the system is illustrated in FIG. 7. The system can include a computer 702 configured to receive financial information for a customer seeking to purchase an automobile. The computer can be located at an automobile dealership. Alternatively, the computer can be at a public or private location such as the customer's house. The customer, a salesperson, an administrative assistant, or other qualified individual can enter the customer's financial information into a graphical user interface displayed on the computer.

A remote database 704 can be in communication with the computer 702. The remote database may be located on a separate computer or server. The database can be in communication with the computer 702 through a local area network, a wide area network, through the internet 706, or another type of communication means. The remote database contains historical data representing a historical probability for a purchaser to accept an offer over a range of financing rates.

A filtering module 710 can be used to filter the historical data contained in the remote database based on the financial information input into the computer, as previously discussed. For example, the historical data may be filtered based on financial information such as whether the customer is a direct purchaser or an indirect purchaser, the geographic location of the customer, an age of the automobile, a loan to value amount based on a ratio of the value of the car to the amount of the loan, a term of payment desired by the customer, a credit rating of the customer, and an income of the customer. Other types of financial information can also be used to filter the database, as can be appreciated. The filtered data can provide a historical data subset that is more applicable to the customer seeking to purchase the automobile.

A curve fitting module 714 is used to apply a plurality of mathematical curve fitting models to the historical data subset to supply a plurality of historical data subset curves. As previously discussed, curve fitting models such as the logit model, the probit model, the win-loss normal distribution model, the win-loss gama distribution model, the gamma cumulative density function model, and other types of curve fitting models can be used to fit a curve to the historical data subset. The plurality of curves can represent various types of statistical data fitting models. The use of a greater number of models can increase the probability that one of the models can provide a relatively accurate fit to the historical data subset, no matter the distribution of the data. Each curve fitting model can provide a different historical data subset curve.

A likelihood probability module 718 can calculate a likelihood probability value for each of the historical data subset curves and select a best fitting historical data subset curve based on the likelihood probability value for each historical data subset curve. For example, the historical data subset curve with the greatest likelihood probability value can be selected as the best fitting historical data subset curve. The likelihood probability value for each curve can be determined using equations (2) and (3), as previously discussed.

An expected profit module 722 can combine a profit function curve and the best fitting historical data subset curve to provide an expected profit curve. The profit function curve and the best fitting curve can be combined using piecewise multiplication of the profit function curve and the best fitting curve to form the expected profit curve. A peak of the expected profit curve represents a maximum expected profit obtained from financing a sale of the automobile at a selected rate, as previously discussed.

A computer display 726 is in communication with at least one of the computer and the remote database. The display is configured to display information related to the expected profit curve to enable a finance offer to be made to the customer for the automobile based on the information in the expected profit curve. The computer display may be connected directly to the computer 702. Alternatively, the display may be located at a separate location, such as the customer's home or business. The display may be used by a salesperson to make an offer to the customer. Alternatively, the information relating to the expected profit curve can be sent over the internet to a display viewed by the customer. Thus, the display may represent the offer made to the customer based on the information provided by the expected profit curve, as previously discussed. For example, a customer may submit his or her financial information over the internet. The system described above can be used to make an offer and send it to the customer's computer display based on the output of the expected profit module for a selected automobile.

The various modules discussed in the exemplary embodiment, such as the filtering module 710, the curve fitting module 714, the likelihood probability module 718, and the expected profit module 722 may be located on the computer 702, the remote database 704, or another computer connected to at least one of the computer and remote database through the internet 706. The modules are described separately to provide an exemplary illustration. However, the actual software code may be implemented in a number of ways, wherein the separate components of the system may be realized using various hardware, software, and firmware components as needed. The modules may be included in a single software program configured to operate on the computer, a remote server, or both. The modules may also be accessed via the Internet to enable a potential customer to receive an automated estimate over an Internet connected computer.

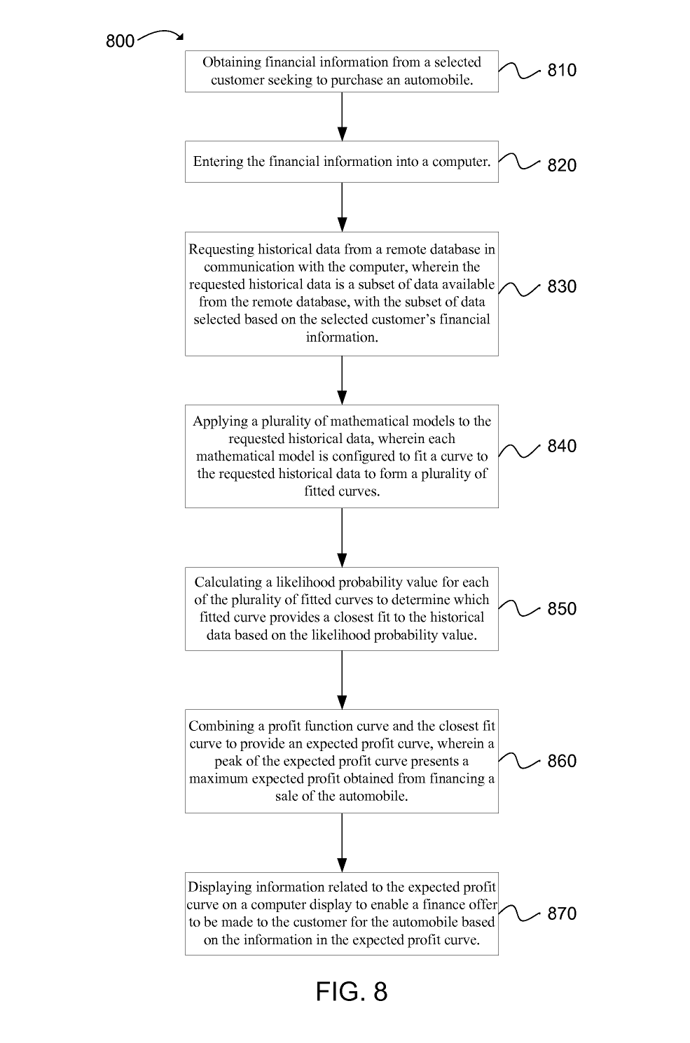

Another embodiment of the present invention provides a method 800 for determining an expected profit obtained through financing a sale of an automobile, as depicted in the flow chart of FIG. 8. The method includes the operation of obtaining financial information from a selected customer seeking to purchase an automobile, as shown in block 810. An additional operation includes entering the financial information into a computer, as shown in block 820.

The method 800 further includes requesting 830 historical data from a remote database in communication with the computer. The remote database can be in communication with the computer through a local area network, a wide area network, the internet, or another communications means. The historical data represents purchasing decisions made by previous automobile purchasers. The requested historical data is a subset of the data available from the remote database. The subset of data is selected based on the selected customer's financial information, as previously discussed.

An additional operation of the method 800 includes applying 840 a plurality of mathematical models to the requested historical data. Each mathematical model is configured to fit a curve to the requested historical data to form a plurality of fitted curves. A likelihood probability value can be calculated 850 for each of the plurality of fitted curves to determine which fitted curve provides a closest fit to the historical data based on the likelihood probability value. A profit function curve is combined 860 with the closest fit curve to provide an expected profit curve. A peak of the expected profit curve presents a maximum expected profit obtained from financing a sale of the automobile. Information related to the expected profit curve is displayed 870 on a computer display to enable a finance offer to be made to the customer for the automobile based on the information in the expected profit curve. The computer display may be located at an automobile sales office, thereby enabling a sales person to provide an offer based on the information related to the expected profit curve shown on the display. Alternatively, the computer display may be the customer's computer display. In the latter case, an offer based on the expected profit curve can be sent to the customer and displayed on the customer's computer.

While the examples illustrated above are used to calculate an optimal interest rate when financing the purchase of a commodity such as a vehicle, the same method can also be used to determine an optimal price by plotting historical data based on price in lieu of the graphs (FIGS. 1-5) showing data based on interest rate. The method can apply multiple prospective models to each fit a different winning probability function with respect to price for a given commodity or business opportunity. The best fitted model can be selected based on a modified likelihood measurement of the fitted models shown in equations (2) and (3), as previously discussed. The method therefore can be used to determine the optimal price based on the best fitted winning probability function and a given profit function.

The business opportunities can be segmented based on the business channel through which the opportunity flows, the type of product, customer and deal attributes, and so forth. A winning probability model can be applied to the deals within a particular segment. A historical data subset can be requested from a remote database containing historical data associated with a particular business opportunity based on segmentation information entered into a computer.

In one embodiment of the present invention, a probability density function can be applied to historical data comprising winning price data in which a customer accepted a business opportunity and losing price data in which a customer rejected a business opportunity. The winning price and losing price can be fitted as normal distributions based on a histogram of winning deals and loss deals over a price range. The winning probability can be estimated as a function of the winning price's probability density function, the losing price's probability density function, the number of winning deals, and the number of losing deals.

Alternatively, the winning price and losing price can be fitted as gamma distributions based on a histogram of winning deals and loss deals over a price range. The winning probability can be estimated as a function of the winning price's probability density function, the losing price's probability density function, the number of winning deals, and the number of losing deals. Additionally, as previously discussed, the winning probability function can be fit with respect to price as a horizontally reversed gamma cumulative density function.

The multiple prospective models used to fit a curve to a data set that includes historical win/loss data for a given business opportunity can include a plurality of different models that may apply differently shaped curves to the data-set. For example, the following prospective models may be applied to the data-set: logit, probit, win-loss normal distribution, win-loss gamma distributions, and a horizontally reversed gamma cumulative density function. Other types of models may also be used to fit a selected data-set with a predetermined shape.

Each of the curves fitted to the data using the multiple prospective models can be evaluated using a modified likelihood measurement, as previously discussed. In one embodiment, the best model can be selected that has the highest likelihood measurement.

A system for determining an expected profit obtained through selling a commodity can include a computer configured to receive segmentation information for a selected customer seeking to purchase the commodity. The segmentation information can be based on the business channel through which the opportunity flows, the type of product, customer and deal attributes, and so forth.

A remote database can be in communication with the computer. The remote database can contain historical data representing a historical probability for a purchaser to accept an offer over a range of prices. A filtering module can filter the historical data contained in the remote database based on the segmentation information input into the computer to provide a historical data subset.

A curve fitting module is used to apply a plurality of mathematical curve fitting modules to the historical data subset to supply a plurality of historical data subset curves. A likelihood probability module calculates a likelihood probability value for each of the historical data subset curves and selects a best fitting historical data subset curve based on the likelihood probability value for each historical data subset curve. An expected profit module can combine a profit function curve and the best fitting historical data subset curve to provide an expected profit curve. A peak of the expected profit curve represents a maximum expected profit obtained from a sale of the commodity at a selected price.

A computer display in communication with at least one of the computer and the remote database is configured to display information related to the expected profit curve to enable an offer to be made to the customer for the commodity based on the information.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method for determining an expected profit obtained through financing a sale of an automobile, comprising:
obtaining financial information from a selected customer seeking to purchase an automobile;
entering the financial information into a computer;
requesting historical data from a remote database in communication with the computer, the historical data representing purchasing decisions made by previous automobile purchasers, wherein the requested historical data is a subset of data available from the remote database, with the subset of data selected based on the selected customer's financial information;
applying a plurality of mathematical models to the requested historical data, wherein each mathematical model is configured to fit a curve to the requested historical data to form a plurality of fitted curves;
calculating a likelihood probability value for each of the plurality of fitted curves to determine which fitted curve provides a closest fit to the historical data based on the likelihood probability value;
combining a profit function curve and the closest fit curve to provide an expected profit curve, wherein a peak of the expected profit curve presents a maximum expected profit obtained from financing a sale of the automobile;
displaying information related to the expected profit curve on a computer display to enable a finance offer to be made to the customer for the automobile based on the information in the expected profit curve.

2. A method as in claim 1, wherein requesting historical data from a remote database further comprises requesting historical data from a remote database wherein the remote database is contained on a server that is in communication with the computer through at least one of a local area network, a wide area network, and an internet connection.

3. A method as in claim 1, further comprising normalizing each of the plurality of fitted curves prior to calculating the likelihood probability value for each of the plurality of fitted curves.

4. A method as in claim 1, wherein combining the profit function curve and the closest fit curve further comprises performing a piecewise multiplication of the profit function curve and the closest fit curve to form the expected profit curve.

5. A method as in claim 1, wherein displaying information related to the expected profit curve on the computer further comprises configuring a graphical user interface that enables a business to set a range about the maximum expected profit on the expected profit curve in which the salesperson can provide multiple offers to the selected customer.

6. A method as in claim 1, wherein applying a plurality of mathematical models to the historical data further comprises applying a mathematical model selected from the group consisting of a logit model, a probit model, a win-loss normal distribution model, a win-loss gamma distribution model, and a gamma cumulative density function model.

7. A method as in claim 1, wherein obtaining financial information from a selected customer further comprises obtaining financial information selected from the group consisting of whether the customer is a direct purchaser, whether the customer is an indirect purchaser, a geographic location of the customer, an age of the automobile, a loan to value amount based on a ratio of the value of the car to the amount of the loan, a term of payment desired by the customer, a credit rating of the customer, and an income of the customer.

8. A system for determining an expected profit obtained through financing a sale of an automobile, comprising:
a computer configured to receive financial information for a customer seeking to purchase an automobile;
a remote database in communication with the computer, wherein the remote database contains historical data representing a historical probability for a purchaser to accept an offer over a range of financing rates;
a filtering module that filters the historical data contained in the remote database based on the financial information input into the computer to provide a historical data subset;
a curve fitting module that applies a plurality of mathematical curve fitting models to the historical data subset to supply a plurality of historical data subset curves;
a likelihood probability module that calculates a likelihood probability value for each of the historical data subset curves and select a best fitting historical data subset curve based on the likelihood probability value for each historical data subset curve;
an expected profit module that combines a profit function curve and the best fitting historical data subset curve to provide an expected profit curve, wherein a peak of the expected profit curve presents a maximum expected profit obtained from financing a sale of the automobile at a selected rate;
a computer display in communication with at least one of the computer and the remote database and configured to display information related to the expected profit curve to enable a finance offer to be made to the customer for the automobile based on the information in the expected profit curve.

9. A system as in claim 8, wherein the curve fitting module is further configured to normalize the historical data subset curves.

10. A system as in claim 8, wherein the plurality of mathematical curve fitting models are selected from the group consisting of a logit model, a probit model, a win-loss normal distribution model, a win-loss gamma distribution model, and a gamma cumulative density function model.

11. A system as in claim 8, wherein the remote database operates on a server connected to the computer through at least one of a local area network, a wide area network, and an Internet connection.

12. A system as in claim 12, wherein the filtering module, the curve fitting module, the likelihood probability module, and the expected profit module operate on at least one of the computer and the server.

13. A system as in claim 8, wherein the financial information for the customer is selected from the group consisting of whether the customer is a direct purchaser, whether the customer is an indirect purchaser, a geographic location of the customer, an age of the automobile, a loan to value amount based on a ratio of the value of the car to the amount of the loan, a term of payment desired by the customer, a credit rating of the customer, and an income of the customer.

14. A system as in claim 8, wherein the expected profit module combines the profit function and the best fitting historical data subset curve using piecewise multiplication.

15. A system for determining an expected profit obtained through selling a commodity, comprising:
a computer configured to receive segmentation information for a selected customer seeking to purchase the commodity;
a remote database in communication with the computer, wherein the remote database contains historical data representing a historical probability for a purchaser to accept an offer over a range of prices;
a filtering module that filters the historical data contained in the remote database based on the segmentation information input into the computer to provide a historical data subset;
a curve fitting module that applies a plurality of mathematical curve fitting models to the historical data subset to supply a plurality of historical data subset curves;
a likelihood probability module that calculates a likelihood probability value for each of the historical data subset curves and selects a best fitting historical data subset curve based on the likelihood probability value for each historical data subset curve;
an expected profit module that combines a profit function curve and the best fitting historical data subset curve to provide an expected profit curve, wherein a peak of the expected profit curve presents a maximum expected profit obtained from a sale of the commodity at a selected price;
a computer display in communication with at least one of the computer and the remote database and configured to display information related to the expected profit curve to enable an offer to be made to the customer for the commodity based on the information.

16. A system as in claim 15, wherein the plurality of mathematical curve fitting models are selected from the group consisting of a logit model, a probit model, a win-loss normal distribution model, a win-loss gamma distribution model, and a gamma cumulative density function model.

17. A system as in claim 15, wherein the remote database operates on a separate computer connected to the computer through at least one of a local area network, a wide area network, and an internet connection.

18. A system as in claim 15, wherein the curve fitting module is further configured to normalize the historical data subset curves.

19. A system as in claim 15, wherein the expected profit module is further configured to provide a graphical user interface that enables a business to set a range about the maximum expected profit on the expected profit curve in which the salesperson can provide multiple offers to the selected customer.
